(19) United States
(12) Patent Application Publication
(10) Pub. No.: US 2009/0261080 A1
(43) Pub. Date: Oct. 22, 2009

(54) ENHANCED PLASMA FILTER

(76) Inventors: Jeremy C. CHERON, Alexandria, VA (US); Soorena SADRI, Alexandria, VA (US); Vernon Eric STATON, Lexington, VA (US)

Correspondence Address: Stuart Smith, 10411 Samage Drive, Oakton, VA, 22124, US

(21) Appl. No.: 12/260,322

(22) Filed: Oct. 29, 2008

Related U.S. Application Data
(63) Continuation-in-part of application No. 11/595,948, filed on Nov. 13, 2006, now Pat. No. 7,446,289.
(60) Provisional application No. 60/735,217, filed on Nov. 10, 2005.

(51) Int. Cl. B23K 9/00

(52) U.S. Cl. 219/121.36

(57) ABSTRACT

A device is provided for compressing a plasma stream flowing in a plasma flow direction and maintaining the plasma stream in the compressed state. The device has a plasma compression region; a plurality of first magnets positioned around the plasma compression region for compressing the plasma stream, each of the first magnets having a dominant magnetic force direction that is non-parallel to the plasma flow direction; a reaction region positioned down stream from the plasma compression region; and a plurality of second magnets positioned around the reaction region for maintaining the plasma stream in its compressed state.

This application is a continuation-in-part application of U.S. patent application Ser. No. 11/595,948, filed Nov. 13, 2006, which claims priority to U.S. Provisional Patent Application No. 60/735,217, filed Nov. 10, 2005, both of which are incorporated by reference herein in their entirety.

### BACKGROUND OF THE INVENTION

The invention relates to plasma creation. In particular, embodiments of the invention relate to the compression of plasma to increase the temperature of the plasma.

### SUMMARY OF THE INVENTION

Embodiments of the invention provide a device for compressing a plasma stream flowing in a plasma flow direction and maintaining the plasma stream in the compressed state. The device has a plasma compression region; a first plurality of magnets positioned around the plasma compression region for compressing the plasma stream, each of the first plurality of magnets having a dominant magnetic force direction that is non-parallel to the plasma flow direction; a reaction region positioned down stream from the plasma compression region; and a second plurality of magnets positioned around the reaction region for maintaining the plasma stream in its compressed state.

Other embodiments of the invention provide a method for compressing a plasma stream flowing in a plasma flow direction and maintaining the plasma stream in the compressed state. The method includes feeding a plasma stream into a plasma compression region; positioning a plurality of first magnets around the plasma compression region for compressing the plasma stream, each of the first magnets having a dominant magnetic force direction that is non-parallel to the plasma flow direction; providing a reaction region positioned down stream from the plasma compression region; and positioning a plurality of second magnets around the reaction region for maintaining the plasma stream in its compressed state.

### BRIEF DESCRIPTION OF THE DRAWINGS

The invention is explained below in further detail with the aid of exemplary embodiments shown in the drawings, wherein:

FIG. 1 is a side view of an example of a plasma device in accordance with an embodiment of the invention;

FIG. 2 is a top view of the device shown in FIG. 1;

FIG. 3 is a partial view including portions of the interior of the device shown in FIGS. 1 and 2;

FIG. 4 is a partial view of a second example of an embodiment of the invention; and

FIG. 5 is a schematic view of an alternate embodiment of the invention.

### DETAILED DESCRIPTION OF THE INVENTION

The invention is explained in the following with the aid of the drawings in which like reference numbers represent like elements.

Particular embodiments of the invention can be used to clean, filter and/or process waste, either gas, solid or liquid waste, by high end plasma creation. Allowing for heat generation and/or the conversion of the fed waste material into hydrogen or other fuel sources by a down stream gasification and processing process based on standard chemical engineering methods. Other embodiments of the invention use the compressed high temperature plasma for propulsion, or as a simple burning tool.

Examples of particular embodiments of the invention use an electric device (for example, electrodes) to turn a safe clean abundant gas into a plasma. The plasma is immediately moved into an area where a specially designed combination of magnets, for example electromagnets, squeeze the plasma to a higher temperature and contain it over a longer distance than what would normally be expected by the electric device alone. At some point over that distance, waste is injected into the chamber and interacts with the plasma. As the plasma travels along the chamber's axis, the momentum, pressure and temperature of the plasma breaks up the waste. As the waste breaks up, a vacuum system and heat exchanger, working with systems like, for example, gas centrifiges or magnetic mass separators, separates the leftover materials into groups where they can be scrubbed, filtered, processed, converted to a fuel or secondary product and/or reused. For a minimal input power, an initial plasma of a few thousand degrees Kelvin over a few inches can be generated. With the extra configuration of magnetic fields it is estimated that this initial plasma temperature can be raised to several hundred thousand degrees Kelvin for a few feet or more. This temperature and distance is large enough to process large amounts of waste water per day, and reduce dangerous compounds down to fairly stable and safe components.

Plasma heating by adiabatic compression is used in fusion research. The invention solves the problems of plasma instability by using a special magnetic configuration. This configuration also allows greater field strengths for very little to no increases in power, which greatly increases plasma temperature, density and momentum compared to previous designs. In addition to enhanced stability and increased temperature for roughly the same power, the invention's field configuration also creates a “magnetic nozzle” which keeps the plasma confined and directed efficiently for a longer time after it leaves the main magnetic field, keeping its momentum and temperature better directed at the target (this would also help efficiency in space flight applications).

The enhanced plasma system uses adiabatic compression to raise plasma temperature and density, and focus it into a channel where it can break-up medical or other waste. The plasma temperature can be controlled between an estimated 20,000 and 1 million degrees Kelvin depending on the operational requirements and design choice of the system. The momentum and density of the plasma can also be controlled based on the operation and design.

Examples of the invention break the waste material into two or more categories and turn them into a slurry or solid waste deposit depending on their composition and make up. The waste is then injected into the reaction chamber, through which the plasma jet will travel. The plasma jet will heat the waste up to the required temperature causing the compounds to break up and many of the atoms to ionize. Ionization will depend on the atomic number, and composition breakup will depend on the material and temperature. At the temperatures used in the invention, all compositions should easily break up and most of the atoms. should ionize. If the material is tougher, the temperature can be raised and/or the plasma jet narrowed to add its momentum to breaking up the compounds. It is noted that not much exists that will not be turned into a gas of individual atoms at temperatures approaching one million degrees Kelvin.

The invention provides no possibility of nuclear fission or fusion, so there is no chance of atomic explosion. The atoms that are ionized will, when cooled, simply require their electrons. The compounds, as a gas of individual atoms will proceed to a series of cooling and filtering by standard means of HEPA filters, HEME filters, scrubbers and mass/density separators. Radioactive materials, like cesium, that are already in waste materials being processed, will come out of the filter as radioactive as they went in, so those types of materials will have to be separated and continue to be disposed of by the federal, state and local measures already in place.

The invention is more efficient than previous methods and allows greater stability and higher temperatures to be generated.

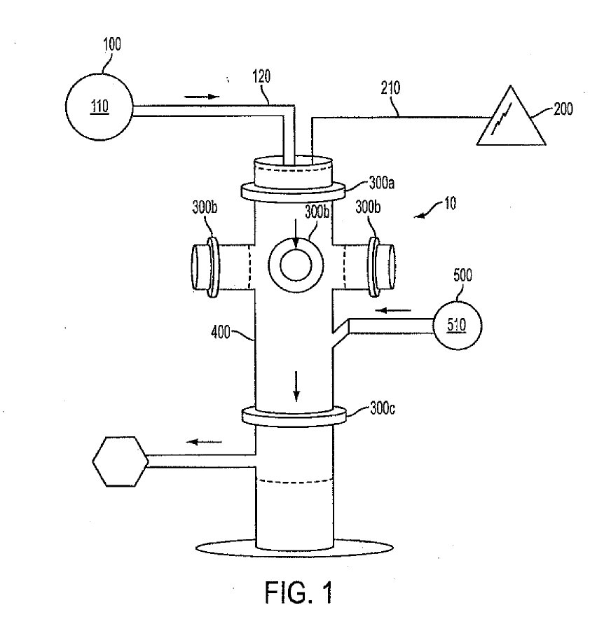

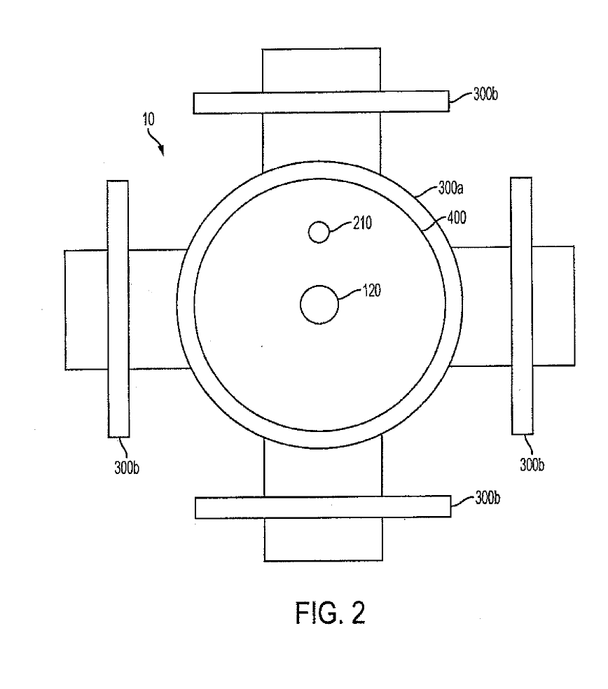

FIG. 1 shows an example of a plasma filter device 10 in accordance with the invention. Plasma filter device 10 is connected to a reactant gas supply 100 that supplies a reactant gas 110 to plasma filter device 10 through a supply pipe 120. A pulsating high voltage system 200 supplies power to plasma filter device 10 through supply line 210. FIG. 2 shows a top view of plasma filter device 10.

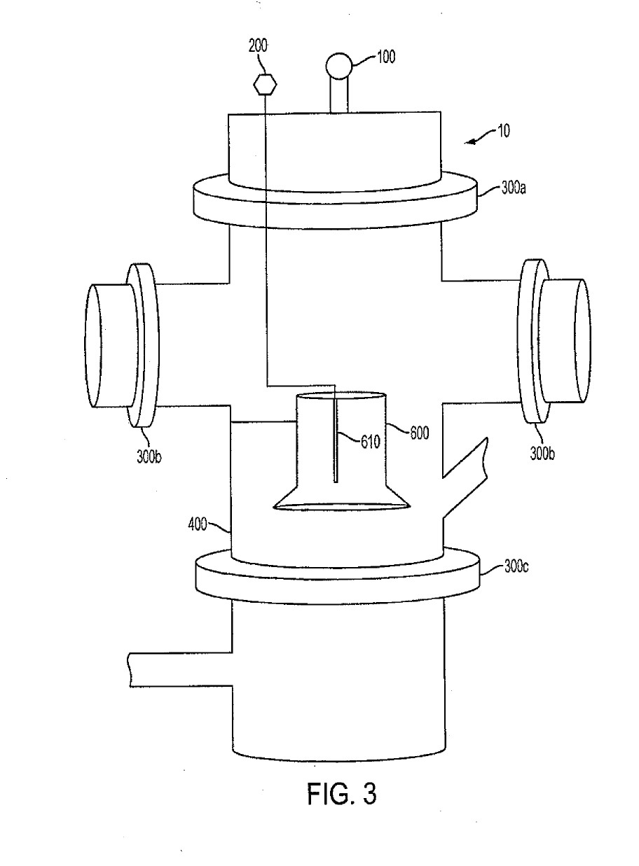

Reactant gas 110 is converted to plasma before it enters scrubber chamber 400 by plasma generation means such as plasma torches, electrode arrays, helicon antennas and many other methods. Surrounding the plasma generation device is the system of magnets that will compress the plasma to high temperatures and densities. FIG. 3 is a partial view of plasma filter device 10 in which portions of the interior of plasma filter device 10 are shown. Immediately prior to scrubber chamber 400 in the path of plasma flow, the plasma passes through an anode shell 600 which can be, for example, tungsten or aluminum. A cathode rod 610 is positioned with anode shell 600. Cathode rod 610 can be, for example, tungsten.

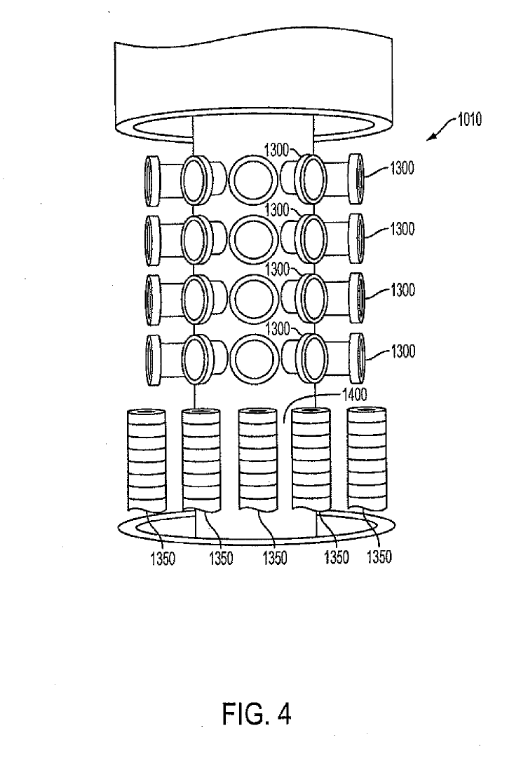

FIG. 4 shows another example of a plasma filter device 1010. Plasma filter device 1010 has two arrays of magnets oriented differently relative to scrubber chamber 1400. When the gas enters the cathode/anode (as an example, but several methods for generating plasmas like helicon antennas and plasma torches can be used) an intense electric field generated between the anode and cathode causes the reactant gas (for example, hydrogen, argon, or oxygen) to become stripped of its electrons and form a plasma (this can involve a single plasma generation device or an array of them, power by conventional means or by an advanced tank circuit or high power system, to produced a large area plasma). At this stage a series of electromagnets 1300 positioned around the plasma and in certain order causes the plasma to be squeezed to a higher temperature. The plasma filter device 1010 shows multiple layers or magnets 1300 several segments long with flipped magnets 1350 acting as a channel to maintain the plasma stream in the compressed state. An example of the invention that was modeled had 20 circumferential sets of magnets, each circumferential set having 36 magnets (represented by reference number 1300 in FIG. 4). These magnets 1300 progressively compress the plasma stream into a more and more compressed stream as the plasma stream moves through the chamber. Below (in the example shown in FIG. 4) the array of magnets 1300, the array of magnets 1350 are positioned in 36 columns of 10 magnets each. In this example, magnets 1350 are positioned such that they are rotated 90 degreed relative to magnets 1300. The magnets can be made of superconducting materials like, for example, Neodymium or plain conductors like, for example, copper and can be stand alone or cooled by, for example, air, water or liquid nitrogen. They can also be air cored or filled.

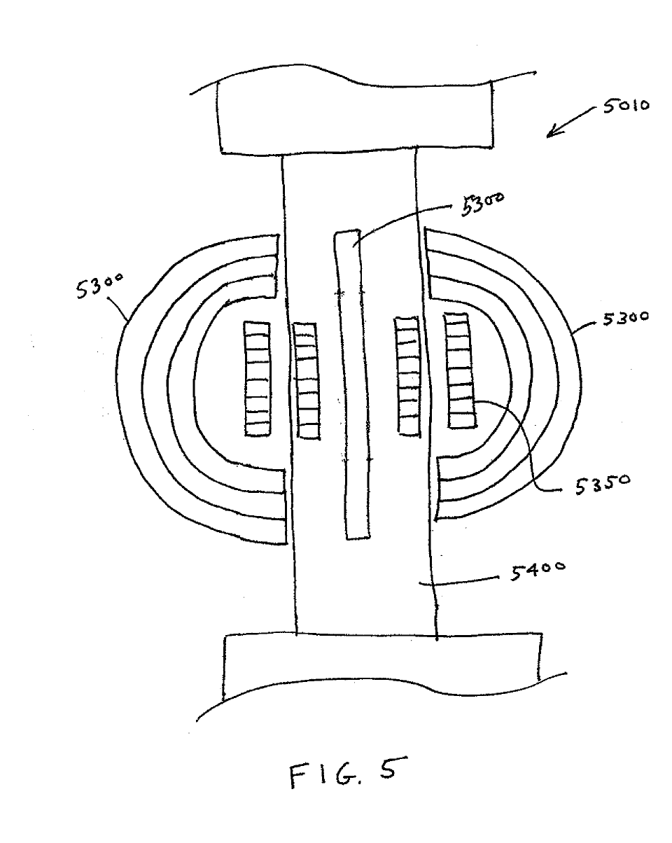

FIG. 5 shows an example of a plasma filter device 5010. Plasma filter device 5010 has two arrays of magnets oriented differently relative to scrubber chamber 5400. Plasma filter device 5010 is similar to plasma filter device 1010 shown in FIG. 4. However, the series of electromagnets 1300 in FIG. 4 are replaced by a series of electromagnets 5300, which are non-linear such as, for example, horseshoe magnets, pie-wedge magnets and so on. In this example, magnets 5300 are semicircular (U-shaped). The plasma filter device 5010 shows three layers or magnets 5300, but any number of layers can be used. Also, any number of sets of magnets 5300 can be used. Magnets 5350 are similar to magnets 1350 shown in FIG. 4. Non-linear electromagnets like these are used because they can each direct more of their total flux to the specific area between their poles than regular solenoid magnets can, resulting in a much greater flux increase in the compression area per magnet.

Magnets 1300, 5300 have a dominant magnetic force direction substantially perpendicular to the plasma flow direction. That is to say that the poles of magnets 1300, 5300 are facing the plasma substantially perpendicular to its flow. Magnets 1350, 5350 have a dominant magnetic force direction substantially parallel to the plasma flow direction. That is to say that the poles of magnets 1350, 5350 are facing the plasma substantially parallel to its flow.

The effect that has been modeled and tested is to increase the flux though a constant area that will increase the regional magnetic field. As the magnetic field enclosing the plasma is increased the plasma is adiabatically compressed and the temperature increased. Various configurations and combinations of magnets can be used to focus more magnetic flux in a constant area to increase magnetic field strength for less current and use that increased magnetic field strength to adiabatically compress the initial plasma to higher densities and temperatures.

Although electromagnets have been used in the above examples, permanent magnets can be used in addition to, or as an alternative to, electromagnets. If permanent magnets are used, mechanisms can be provided to move the permanent magnets relative to the plasma stream. These mechanisms should allow movement of the permanent magnets in directions perpendicular to, and parallel to, the plasma stream in order to permit control and alteration of the magnet field to which the plasma stream is subjected.

Although waste treatment has been used as an example to describe the invention, the invention can also be used to cut and melt steel; heat and clean water; heat and clean air or other gases; remove harmful compounds from soil or dirt; produce gases such as, for example, hydrogen an other combustible gases; produce heat; provide propulsion; and to destroy equipment and other materials. It is also noted that theta or other magnetic pinch configurations can be used. In addition, helicon antenna, plasma torches or electric arcs can be used to generate the pre-ionized gas. The electromagnets can be non-linear, non magnetic mirror electromagnetic coils.

The invention provides many opportunities for cleaning the environment while providing energy in usable forms. This is possible because the invention breaks chemical bonds on the molecular level by subjecting substances to extreme temperatures created by the plasma. One example of such environmental cleaning is the breaking down of harmful chemical compounds known as endocrine disruptors. Although present in very small concentrations in our waters, endocrine disruptors have been found to play a significant role in a number of health issues. The invention can molecularly dissociate, break the structural bonds, of these complex organic and harmful compounds into carbon monoxide and hydrogen gases for subsequent energy recovery or by catalytic reformulation into useful alcohols.

Other harmful substances, such as other pharmaceuticals and explosives, can be processed with the invention to reduce them to safe, or at least less harmful, substances.

The invention has been described in detail with respect to preferred embodiments and it will now be apparent from the foregoing to those skilled in the art that changes and modifications may be made without departing from the invention in its broader aspects. The invention, therefore, is intended to cover all such changes and modifications that fall within the true spirit of the invention.

What is claimed is:

1. A device for compressing a plasma stream flowing in a plasma flow direction and maintaining the plasma stream in the compressed state, the device comprising:
a plasma compression region;
a plurality of first magnets positioned around the plasma compression region for compressing the plasma stream, each of the first magnets having a dominant magnetic force direction that is non-parallel to the plasma flow direction;
a reaction region positioned down stream from the plasma compression region; and
a plurality of second magnets positioned around the reaction region for maintaining the plasma stream in its compressed state.

2. The device of claim 1, wherein the dominant magnetic force direction of each of the first magnets is substantially perpendicular to the plasma flow direction

3. The device of claim 1, wherein each of the second magnets has a dominant magnetic force direction substantially parallel to the plasma flow direction.

4. The device of claim 2, wherein each of the second magnets has a dominant magnetic force direction substantially parallel to the plasma flow direction.

5. The device of claim 1, wherein the device is for adiabatically compressing the plasma stream in the plasma compression region.

6. The device of claim 2, wherein the device is for adiabatically compressing the plasma stream in the plasma compression region.

7. The device of claim 3, wherein the device is for adiabatically compressing the plasma stream in the plasma compression region.

8. The device of claim 1, wherein at least one of the first magnets is U-shaped.

9. The device of claim 2, wherein at least one of the first magnets is U-shaped.

10. The device of claim 1, further comprising a waste introduction device for introducing waste to be processed into the reaction region,
wherein the reaction region is adapted to contain the waste and the plasma stream in its compressed state such that the plasma heats the waste and breaks down the waste.

11. A method for compressing a plasma stream flowing in a plasma flow direction and maintaining the plasma stream in the compressed state, the method comprising:
feeding a plasma stream into a plasma compression region;
positioning a plurality of first magnets around the plasma compression region for compressing the plasma stream, each of the first magnets having a dominant magnetic force direction that is non-parallel to the plasma flow direction;
providing a reaction region positioned down stream from the plasma compression region; and
positioning a plurality of second magnets around the reaction region for maintaining the plasma stream in its compressed state.

12. The method of claim 11, wherein the dominant magnetic force direction of each of the first magnets is substantially perpendicular to the plasma flow direction

13. The method of claim 11, wherein each of the second magnets has a dominant magnetic force direction substantially parallel to the plasma flow direction.

14. The method of claim 11, wherein the plasma stream is adiabatically compressed in the plasma compression region.

15. The method of claim 13, wherein the plasma stream is adiabatically compressed in the plasma compression region.

16. The method of claim 14, wherein at least one of the first magnets is an electromagnet.

17. The method of claim 14, wherein at least one of the second magnets is an electromagnet.

18. The method of claim 13, wherein at least one of the first magnets is U-shaped.

19. The method of claim 11, further comprising introducing waste to be processed into the reaction region,
wherein the reaction region is adapted to contain the waste and the plasma stream in its compressed state such that the plasma heats the waste and breaks down the waste.

20. The method of claim 19, wherein the waste is contaminated soil, contaminated dirt, contaminated earth or contaminated sand.
